(19) United States
(12) Patent Application Publication
(10) Pub. No.: US 2007/0084366 A1
(43) Pub. Date: Apr. 19, 2007

(54) Printer image drum support

(75) Inventors: Daniel W. Costanza, Webster, NY (US); Kasilingam Arumugam, Coimbatore (IN); Michael F. Leo, Penfield, NY (US)

Correspondence Address: MARGER JOHNSON & MCCOLLOM, P.C., 210 SW MORRISON STREET, SUITE 400, PORTLAND, OR, 97204, US

(73) Assignee: Xerox Corporation

(21) Appl. No.: 11/254,368

(22) Filed: Oct. 19, 2005

(51) Int. Cl. B41F 13/193; B41J 2/01; B41J 29/00

(52) U.S. Cl. 101/375; 347/103

(57) ABSTRACT

A printer image drum is provided that includes a cylindrical drum formed of a first material, a bearing formed of a second material and an end bell formed of the first material with the end bell mounting the cylindrical drum on the bearing. The image drum is structured so that the bearing is plastically undeformed at a temperature of about 20° C. and so that an outer face of the cylindrical drum retains a consistently cylindrical shape at about 70° C.

### TECHNICAL FIELD

The present disclosure is directed toward ink-jet printing, in particular toward an intermediate drum for accepting ink in imagewise fashion thereon for transfer to print media.

### BACKGROUND

In current transfer inkjet printers, the ink is transferred from a printhead to a rotating image drum. After the ink has been transferred to the drum, the print media is rolled between a transfix roller and the image drum with the transfix roller exerting a force against the print media pressing the print media against the drum.

The word “printer” as used herein encompasses any apparatus, such as digital copier, bookmaking machine, facsimile machine, multi-function machine, etc. that performs a print outputting function for any purpose.

Due to the properties of the inkjet ink, the ink transfer occurs at a relatively high temperature of about 70° C. To further help with heat conductance, the drum is typically made from a good heat conductor like aluminum. The pressure from the transfix roll onto the print media and image drum can be about 3000 Newtons.

With current inkjet printers, the image is transferred from the printhead to image drum prior to the transfix roll feeding the print media onto the image drum. Using this process, no other forces are exerted against the image drum while the printhead transfers ink to the image drum, ensuring a consistent positioning of the image drum relative to the printhead. The consistent positioning ensures a high quality image.

By first transferring ink, then feeding print media onto the drum, the speed of printing is limited. A way to increase the printing speed is to transfer ink from the printhead concurrent to feeding print media onto the image drum. The transfix roll during the feeding process, however, exerts a pressure against the image drum that can potentially deform or move the image drum thereby moving the position of the image drum relative to the printhead. This movement of the image drum relative to the printhead can be great enough to cause poor print quality. Experiments have shown that image drum-to-printhead motions of 20 microns during printing will create noticeable defects.

In order to increase printing speed by transferring ink from the printhead to the image drum while concurrently feeding print media to the image drum, the support system for the image drum must be mechanically stiff enough to hold the image drum steady during the printing process and, at the same time, account for thermal expansion caused by operating at about 70° C.

### SUMMARY OF THE DISCLOSURE

One embodiment is a printer image drum that includes a cylindrical drum formed of a first material, a bearing formed of a second material and an end bell formed of the first material, where the end bell mounts the cylindrical drum on the bearing. Further, the printer image drum is arranged such that the bearing is plastically undeformed at about 20° C. and an outer face of the cylindrical drum retains a consistently cylindrical shape at about 70° C.

Another embodiment is a printer including a cylindrical printer image drum and a transfix roll to press print media against the image drum by exerting a radially directed pressure against an outer face of the drum. An end bell is positioned between the image drum and a drum bearing to support the image drum on the drum bearing. At a temperature of about 20° C., the end bell exerts a non-deforming pressure on the drum bearing. At a temperature of about 70° C., the end bell supports the image drum against the radially directed pressure of the transfix roll.

### BRIEF DESCRIPTION OF THE DRAWINGS

FIG. 1 is a longitudinal cross-sectional perspective view of an image drum mounted on a bearing and shaft using a solid-shaped end bell.

FIG. 2 is an enlarged perspective cross-sectional view of an image drum mounted on a bearing using an end bell.

FIG. 3 is a side elevation view of the inside of a printer using an image drum mounted on a bearing using an end bell.

FIG. 4 is an enlarged perspective cross-sectional view of an image drum mounted on a bearing using another end bell.

### DETAILED DESCRIPTION

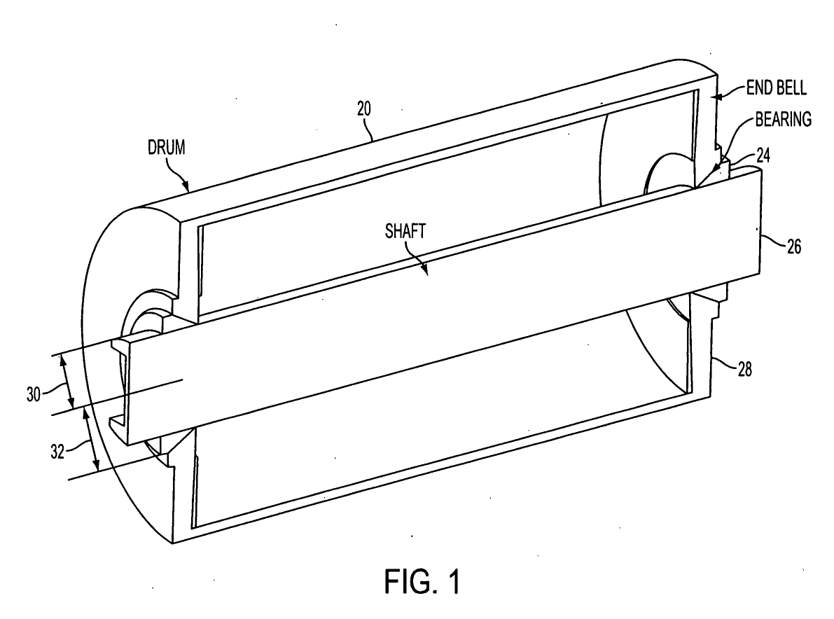

A longitudinal cross-sectional view of an image drum 20 and its supporting structure is shown in FIG. 1. Bearing 24 rotatably supports the aluminum image drum 20 on the shaft 26. Solid end bell 28 further supports the image drum 20 on the roller bearing 24.

End bell is a term used herein to generally describe a support structure with the purpose of supporting a cylindrical drum on a roller bearing and should not viewed as being restricted to bell-shaped structures. As will be described below, the end bell may comprise many different shapes.

One way to mechanically stiffen the support of the image drum 20 is to make the roller bearing 24 and drive shaft 26 out of steel. Due to thermal conductivity needs, however, the image drum 20 is made from aluminum. Because aluminum and steel have differing coefficients of thermal expansion, the end bell 28 needs to both match the expansion rate of the aluminum image drum 20 to provide a consistently cylindrical shape, and the end bell 28 needs to remain in contact with the steel bearing 26 at the high printing temperatures.

To match the expansion rate of the image drum 20, the end bell 28 can be made from a material having a same or similar coefficient of thermal expansion. When the end bell 28 is made from such a material, it will expand greater than a steel outer race of the substantially steel bearing 24 and a gap will result between the end bell 28 and the steel bearing 24 if they start with matching interfacing radii at lower temperatures. Thus, if the end bell 28 is made from such material, the inner interfacing radius 30 of the end bell is less than the outer interfacing radius 32 of the bearing 24 at lower temperatures. This difference in radii provides an interference fit between the two components. It has been found that a solid-shaped end bell 28 exerts too high a pressure on the bearing 24 at lower temperatures when the radii 30 and 32 are sized to match at the printing temperature of about 70° C. resulting in the end bell 28 plastically deforming the outer race of the bearing 24, causing premature bearing failure.

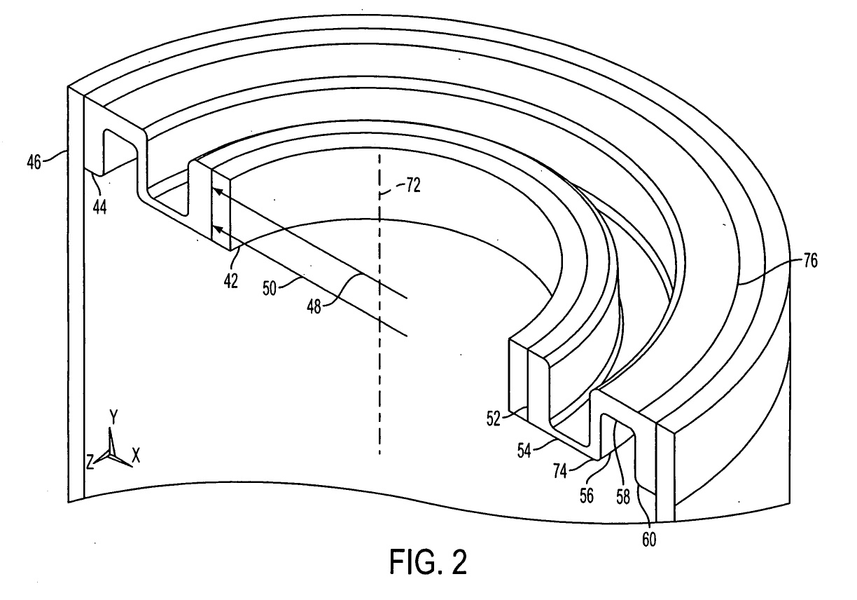

FIG. 2 is an enlarged cross-sectional perspective view of a printer image drum 40. The drum 40 includes a cylindrical drum 46 mounted on a bearing 42 using an end bell 44. The cylindrical drum 46 is formed of a first material. The bearing 42 is formed of a second material and the end bell 44 is formed of the same first material as the cylindrical drum 46. The second material can have a coefficient of thermal expansion that is lower than the coefficient of thermal expansion of the first material.

The first material comprising the cylindrical drum 46 and the end bell 44 can preferably be comprised of aluminum. The second material comprising the bearing can be comprised of steel.

When the end bell 44 is mounted onto the bearing 42 at a temperature of about 20° C., the bearing remains plastically undeformed. When the image drum 40 is heated to printing temperatures of about 70° C., the portion of the end bell 44 making contact with the drum expands the same amount as the cylindrical drum 46 and, thus, the cylindrical drum 46 retains a consistently cylindrical shape.

Because the end bell 44 expands at a greater rate than the bearing 42, the bearing 42 has an outer radius 48 that is greater than the inner interfacing radius 50 of the end bell 44 at a temperature of about 20° C. The differing radii allow the end bell 44 to remain in intimate contact with the bearing 42 when heated to a printing temperature of about 70° C.

The end bell 44 and bearing 42 can remain in intimate contact when the outer radius 48 of the bearing 42 is the same as the inner interfacing radius 50 of the end bell 44 at the printing temperature of about 70° C. The equal radii at the higher temperature ensure that the cylindrical drum 46 does not move radially. To achieve this relationship of radii, the outer radius 48 of the bearing 42 can be at least 125 microns greater than the inner interfacing radius 50 of the end bell 44 at a temperature of about 20° C.

When the outer radius 48 of the bearing 42 is larger than the inner interfacing radius 50 of the end bell 44 at about 20° C., the end bell 44 fits onto the bearing 42 with an interference fit resulting in the end bell 44 exerting a pressure on the bearing 42. As described with reference to FIG. 1, a solid-shaped end bell 28 would exert too much pressure on the bearing and, thus, undesirably plastically deform the bearing. The shape of the end bell 44 allows the end bell 44 to flex (elastically deform) enough so that the end bell 44 does not exert too much pressure on the bearing 42. The particular shape allowing the end bell 44 to flex can be a z-shaped circumferential cross-section.

The z-shaped circumferential cross-section includes inner circumferential leg 52, inner radially extending portion 54, radial middle portion 56, outer radially extending portion 58 and outer circumferential leg 60. The inner side of the inner circumferential leg 52 corresponds to the inner interfacing radius 50 of the end bell 44. The outer side of the outer circumferential leg 60 supports the cylindrical drum 46.

When the image drum 40 is heated to about 70° C., the outer side of the outer circumferential leg 60 continues to support the cylindrical drum 46, and thus, the cylindrical drum retains a consistently cylindrical shape. When the drum 40 is at a temperature of about 20° C., the interference fit between the inner side of the inner circumferential leg 52 and the bearing 42 causes the inner circumferential leg 52 to exert a pressure on the bearing 42. The z-shape of the circumferential cross-section, however, allows the end bell 44 to flex so that the end bell 44 exerts only a non-plastically deforming pressure on the steel bearing 42. The flex can occur because the end bell 44 deforms substantially symmetrically about the radial middle portion 56 allowing the inner circumferential leg 52 and the outer circumferential leg 60 to remain flat against the bearing 42, and cylindrical drum 46, respectively.

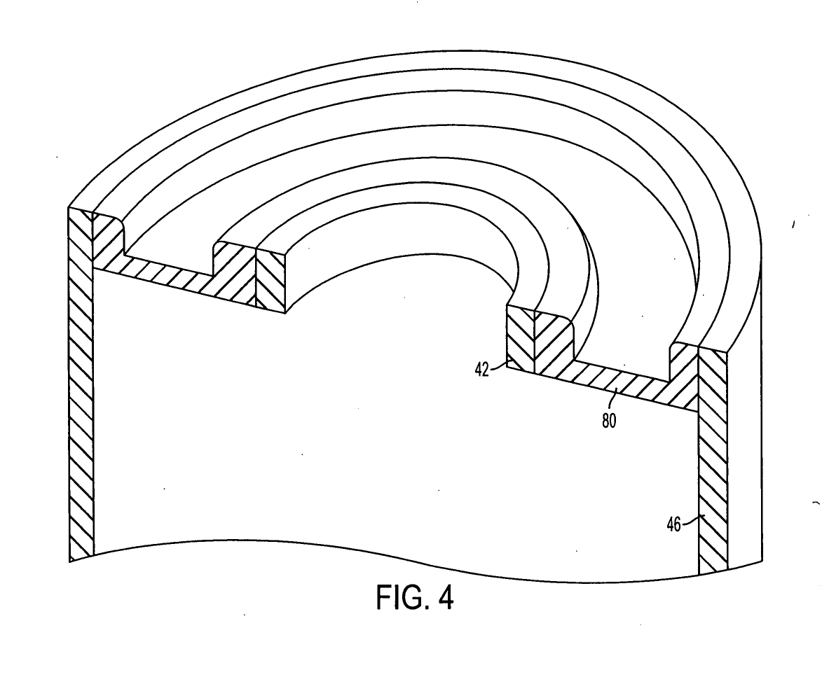

An end bell 80 with a c-shaped circumferential cross-section, as shown in FIG. 4, may provide enough flexure to prevent deformation of the bearing 42 when the drum 40 is at a temperature of about 20° C. The asymmetrical nature of the c-shape in the circumferential direction may result in the inner and outer circumferential legs tilting away from the respective interfacing surfaces of the bearing 42 and cylindrical drum 46.

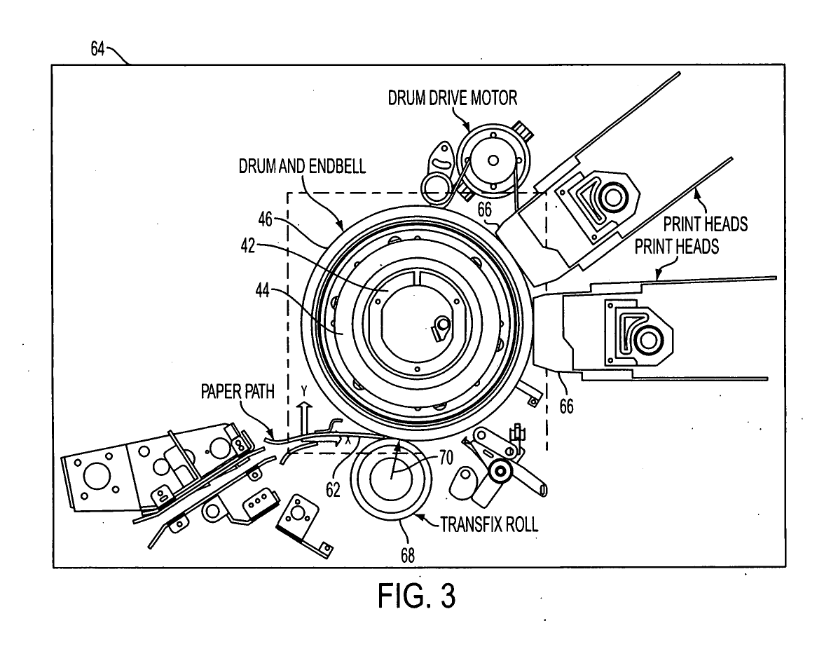

When print media 62, shown in FIG. 3, is fed onto the image drum 40, a pressure is applied in a radial direction to the print media 62 to achieve the proper transfer of the in the inked image on the image drum 40 to the print media 62. The end bell 44, while being flexible enough to prevent deforming of the bearing 42 at lower temperatures, is strong enough to support the cylindrical drum 46 on the bearing 42 responsive to the radially directed force that is applied to the outer face of the cylindrical drum 46. This radially directed pressure can be about 3000 Newtons.

FIG. 3 is a side elevation view of the inside of a printer 64 using a cylindrical image drum 46 mounted on a bearing 42 using an end bell 44 according to another embodiment. Printheads 66 and transfix roll 68 are shown in a printing position such that ink is being transferred from the printheads 66 to the image drum 46 concurrent to the transfix roll 68 feeding the print media 62 against the image drum 46, the transfix roll 68 exerting a radially directed pressure 70 against the outer face of the drum 46.

The end bell 44 is positioned between the image drum 46 and the drum bearing 42 to support the image drum 46 on the bearing 42. When the printing environment is at a temperature of about 20° C., the end bell 44 has an interference fit with drum bearing 42 that exerts a non-deforming pressure on the drum bearing 42. When the printing environment is at a temperature of about 70° C. during the printing process, the end bell 44 supports the image drum 46 against the radially directed pressure 70 of the transfix roll 68. The radially directed pressure 70 can be about 3000 Newtons.

The printheads 66 are shown positioned to transfer ink to the printer image drum 46. While two printheads 66 are shown, it is contemplated that one or more printheads 66 will work with the described embodiment. Because the end bell 44 does not deform the bearing 42 at lower temperatures, no gaps are formed between the bearing 42 and the end bell 44 so the bearing is able to provide consistent support to the end bell 44 at higher printing temperatures and, thus, the end bell 44 is able to provide consistent support to the image drum 46 at higher printing temperatures when the transfix roll 68 exerts the radially directed pressure against the outer face of the drum 46. The end bell's support is consistent enough to provide that a motion of the image drum 46 relative to the printhead 66 is less than 20 microns, which can prevent visible defects from occurring.

The end bell 44 in printer 64 can have the shape shown in FIG. 2. There, the end bell 44 includes middle portion 56 that extends parallel to a longitudinal axis of rotation 72 of the image drum 46. The end bell further includes inner and outer radially extending portions 54 and 58 that are adjacent to opposite longitudinal ends 74 and 76 of the middle portion 56 and extend radially from the middle portion 56.

It will be appreciated that various of the above-disclosed and other features and functions, or alternatives thereof, may be desirably combined into many other different systems or applications. Although the illustrated embodiment shows an image printer drum in the context of an ink-jet printing apparatus, the drum as recited in the claims can be used in conjunction with other printing technologies, such as used as part of a photoreceptor or intermediate drum in xerographic printing, or in offset printing. Various presently unforeseen or unanticipated alternatives, modifications, variations, or improvements therein may be subsequently made by those skilled in the art which are also intended to be encompassed by the following claims.

1. A printer image drum comprising:
a cylindrical drum formed of a first material;
a bearing formed of a second material; and
an end bell formed of the first material to mount the cylindrical drum on the bearing, in which:
the bearing is plastically undeformed at about 20° C.; and
an outer face of the cylindrical drum retains a consistently cylindrical shape at about 70° C.

2. The printer image drum of claim 1 in which the first material has a first coefficient of thermal expansion and the second material has a second lower coefficient of thermal expansion.

3. The printer image drum of claim 2 in which the first material comprises aluminum and the second material substantially comprises steel.

4. The printer image drum of claim 1 in which the end bell has a z-shaped circumferential cross-section.

5. The printer image drum of claim 1 in which the bearing has an outer interfacing radius greater than an inner interfacing radius of the end bell at about 20° C.

6. The printer image drum of claim 5 in which the outer radius of the bearing is at least 125 microns greater than the interfacing inner radius of the end bell at about 20° C.

7. The printer image drum of claim 5 in which an outer radius of the end bell is substantially the same as an inner radius of the cylindrical drum over a temperature range of about 20° C. to about 70° C.

8. An image drum comprising:
a cylindrical aluminum drum;
a substantially steel bearing; and
a means for supporting the cylindrical drum on the bearing, in which:
an outer face of the cylindrical drum retains a consistently cylindrical shape at about 70° C.; and
the means for supporting the cylindrical drum exerts a non-plastically deforming pressure on the steel bearing at about 20° C.

9. The image drum of claim 8 in which the means for supporting the cylindrical drum supports the cylindrical drum responsive to a radially directed force applied to the outer face of the cylindrical drum.

10. The image drum of claim 9 in which the radially directed force applied to the outer face of the cylindrical drum is about 3000 Newtons.

11. The image drum of claim 8 in which the means for supporting the cylindrical drum deforms substantially symmetrically about a radially middle portion of the means when the means exerts the non-plastically deforming pressure on the substantially steel bearing at about 20° C.

12. A printer comprising:
a cylindrical printer image drum; and
a transfix roll to press print media against the image drum to exert a radially directed pressure against an outer face of the drum;
a drum bearing; and
an end bell positioned between the image drum and the drum bearing to support the image drum on the drum bearing, in which:
the end bell is to exert a non-deforming pressure on the drum bearing at about 20° C.; and
the end bell supports the image drum against the radially directed pressure of the transfix roll at about 70° C.

13. The printer of claim 12, further comprising a printhead positioned to transfer ink to the printer image drum,
in which a motion of the image drum relative to the printhead is less than 20 microns when the transfix roll exerts the radially directed pressure against the outer face of the image drum.

14. The printer of claim 12, in which the image drum and end bell are comprised of a first material having a first coefficient of thermal expansion and the drum bearing is comprised of a second material having a second coefficient of thermal expansion that is less than the first coefficient of thermal expansion.

15. The printer of claim 12, in which the image drum and end bell comprises aluminum and the drum bearing substantially comprises steel.

16. The printer of claim 12, in which the end bell includes a middle portion extending parallel to a longitudinal axis of rotation of the image drum.

17. The printer of claim 16 in which the end bell includes portions adjacent to opposite longitudinal ends of the middle portion that extend radially from the middle portion.

18. The printer of claim 12, in which an outer radius of the drum bearing is greater than an inner radius of the end bell at about 20° C.

19. The printer of claim 18, in which the outer radius of the drum bearing is at least 125 microns larger than the inner radius of the end bell at about 20° C.

20. The printer of claim 12, in which the radially directed pressure exerted against the outer face of the drum by the transfix roll is about 3000 Newtons.
